(19) United States
(12) Patent Application Publication
(10) Pub. No.: US 2024/0386024 A1
(43) Pub. Date: Nov. 21, 2024

(54) PROGRAMMABLE CONNECTORS FOR ACCESSING PROFILE DATA

(71) Applicant: Twilio Inc., San Francisco, CA (US)

(72) Inventors: Amool Gupta, Berkeley, CA (US); Dipesh Chauhan, San Francisco, CA (US); Charlie Helin, Murrieta, CA (US); Ruma Nair, San Francisco, CA (US)

(21) Appl. No.: 18/198,657

(22) Filed: May 17, 2023

(51) Int. Cl. G06F 16/9535; G06F 9/54; G06F 16/9538

(52) U.S. Cl. CPC G06F 16/248; G06F 9/548; G06F 16/9538

(57) ABSTRACT

A method of integrating communication data and user data is disclosed. A data object corresponding to a user is generated. The generating includes identifying a reference to communication information pertaining to the user and identifying a reference to user information pertaining to the user. The communication information is managed by a first system. The user information is managed in a second system. Based on a receiving of a request via an API, the data object is used to access a subset of the user information and a subset of the communication information. The subset of the user information and the subset of the communication information are identified in one or more parameters of the API. The subset of the user information and the subset of the communication information is provided for presenting together in a user interface of a client device.

### TECHNICAL FIELD

The disclosed subject matter relates generally to the technical field of cloud-based software-as-service (SaaS) architectures and, in one specific example, to programmable connectors for accessing profile data.

### BACKGROUND

Entities, such as public or private corporations, have unique needs for managing their customer engagement workflows. Current solutions require businesses to make significant investments in hardware and offer only pre-packaged implementations that are limiting.

### BRIEF DESCRIPTION OF THE DRAWINGS

Some embodiments are illustrated by way of example and not limitation in the figures of the accompanying drawings.

FIG. 1 is a network diagram depicting a cloud-based SaaS system within which various example embodiments may be deployed.

FIG. 2 is a block diagram illustrating example modules of the service(s) of FIG. 1.

FIG. 3 is a pseudo-code listing of an example implementation of a Profile Connector Interface.

FIG. 4 is table showing example parameters of an example Profile Connector Interface.

FIG. 5 is a table showing example parameters of an example Profile Interface.

FIG. 6 is a table showing example parameters of an example Address Resource Interface.

FIG. 7 is a table showing example parameters of an example Additional Contact Resource Interface.

FIG. 8 is a table showing example parameters of an example Profile Connection Resource Interface.

FIG. 9 is an example listing of pseudo-code of an example of a profile of a user for when the user is a person or individual.

FIG. 10 is an example listing of pseudo-code of an example of a profile of a user when the user is a business.

FIG. 11 is a screenshot of an example user interface for managing one or more connections.

FIG. 12 is a screenshot of an example user interface for mapping fields in an external source to a profile data object.

FIG. 13 is a block diagram of an example mobile device, according to an example embodiment.

FIG. 14 is a block diagram of a machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

A system, including a software development kit (SDK) (e.g., also referred to herein as “the system” or “the service(s)”), is disclosed that allows an entity to build one or more connectors for integrating one or more sets of communication data stored in a communication system with one or more sets of user data stored in one or more systems that are external from the communication system, such as one or more customer data platform (CDP) systems, one or more customer relationship management (CRM) systems (e.g., Salesforce), one or more information technology service management (ITSM) systems (e.g., ServiceNow), or one or more enterprise resource planning (ERP) systems.

In example embodiments, the integrated data is stored in a unified profile data object. The profile data object is updated automatically and/or made accessible (e.g., via querying) to one or more tools, such as a timeline tool, omnichannel tool, or routing tool, used by the entity to manage or resolve an interaction with a user, as described in more detail herein.

After the one or more sets of communication data is integrated with the one or more sets of profile data, some or all of the integrated data may be (1) surfaced in one or more user interfaces, such as a user interface presented to a representative in a contact center or a manager of one or more representatives in a contact center, (2) surfaced in one or more widgets or canvases, such as a timeline widget or an omnichannel canvas, that may be included in the one or more user interfaces a manager within a contact center, and/or (3) used to make routing decisions or inform routing logic for interactions being processed in a contact center.

One or more timelines or timeline widgets, as described herein, may be generated, stored, accessed, modified, edited, customized, and presented as a visual representation in one or more graphical user interfaces (GUIs), as described herein, and may be configured to include one or more sets or one or more subsets of profile data that is connected via the one or more connectors.

Such timelines may be integrated into one or more customized workflows corresponding to one or more users associated with an entity, such as an end customer identified (e.g., via a customer identity service) as being associated with an incoming communication with the entity. Such engagement workflows may include one or more workflows through a contact center, such as for user (e.g., end customer) journey associated with one or more topics corresponding to an interaction, as described herein. In example embodiments, a topic represents a tag or category selected (e.g., by an external system) from a classification system for classifying an interaction, and may represent an intent of a user. In example embodiments, the timeline and tools for generating, storing, accessing, modifying, customizing, and presenting the timeline may be made accessible (e.g., programmatically, via an API, and/or via one or more GUIs) to one or more users associated with the entity, such as administrators of the entity, representatives of the entity, or systems, including machine-learning systems, chatbots or other systems configured to automate tasks (e.g., including workflow tasks), end customers, and so on, as described herein.

In example embodiments, a timeline includes information pertaining to each of a user's historical interactions with an entity, such as a business entity.

The SDK supports generating specialized and/or customized user data objects; adding, editing, and removing data, including data pertaining to communication data and communication metadata (e.g., corresponding to voice or digital communications managed by a communication platform) and/or user data (e.g., information about an entity's associated users managed by one or more systems of the entity, such as CDP systems of the entity), using the profile data objects; and/or surfacing at least one or more subsets or summaries of the one or more subsets of the data objects in one or more custom applications, such as one or more contact center applications or other communication applications.

In example embodiments, one or more custom applications may call one or more APIs of a timeline feature (e.g., implemented as a software as an application (SaaS) or other service) to access a user data object (e.g., corresponding to the timeline of one or more interactions of the user) to retrieve data pertaining to an interaction of the user. In example embodiments, the data object is specially stored and/or configured to provide efficient real-time access all or one or more subsets of the data stored in or referenced from the timeline object for surfacing in real-time in a custom graphical user interface (GUI), such as a custom user interface configured to present a summary of the data to an agent or representative in a contact center. The representative may then view the summary of the data when determining whether to accept an invitation to process the interaction. If the representative chooses not to accept the invitation, the interaction may be routed to one or more additional representatives, who, in turn, may view a visual representation of the data object, including the summary of the data, and make a decision of whether to accept the invitation.

Upon acceptance of an invitation by a representative, further information pertaining to the timeline may be populated into the user interface of the representative to allow the representative to process the interaction efficiently. In example embodiments, the information that is presented in the representative's user interface at each stage of a user's journey (e.g., a first stage occurring before the representative accepts the invitation, a second stage occurring while the representative is handling or processing the interaction, and a third stage occurring when the representative is done handling or processing the interaction) is customizeable and/or configurable by systems of the representative, the entity, or the customer, or other user, or any combination of such systems (e.g., using the timeline API or options available within one or more user interfaces presented to the users via the systems of the users). Thus, for example, a summary of various data fields may be presented in a visual representation of a user data object in a user interface during the first stage and more detailed information may be presented in the user interface upon accepting of an invitation by a representative in the second stage. In example embodiments, the more detailed information may be based on various factors, such as an association of one or more topics with communication data, user (e.g., end customer) data, and/or metadata pertaining to the interaction that is being handled or processed.

In example embodiments, data pertaining to previous communications of the user, such as data maintained and stored in data stores managed by a communication platform, is merged, aggregated, or integrated with data pertaining to the user, such as the user's profile data or custom data about users, that is managed and stored in systems managed by the entity or accessible from systems managed by the entity separately from the communication platform. In example embodiments, the integration of the separate data sets is performed using the connector built by the entity, as described herein.

The entity can integrate profile data from third-party systems by implementing resolve, create, and update endpoints and adding a generic connector (e.g., CDP connector) block or by adding a CDP-specific connector block. The connector takes application connection details as inputs. The entity registers the connection details as a profile connection resource (e.g., via a post call to the API), and passes the identifier of the created connection as an input to the connector. With the connector registered, the system calls the endpoints registered as part of the connector.

Having the communication platform data aggregated with external data into a profile data object and using an API to query the profile data object provides more efficient access to the data (e.g., for handling an interaction in real time) than other aggregation techniques, such as, for example, querying the external system directly when the data is needed.

In example embodiments, the connector allows one or more of the following actions to be performed: mapping or determining of an incoming communication to a user profile, creating a user profile for a new user, updating the user profile of a user, or searching for a user based on inputs, such as a phone number, name, or email address.

In example embodiments, the representative may specify one or more values of one or more new data items and modify the data object corresponding to an interaction such that the values are merged or added to the data object. The one or more new data items may then be accessible to subsequent representatives who access the data object, such as when an interaction is routed to the one or more subsequent representatives for handling or processing the interaction. In example embodiments, one or more of the data values stored with respect to the data object may be references to data items rather than actual values of data items. Thus, for example, user data, such as user data that is stored in systems managed by the entity separately from the communication platform. may be associated with the user data object without requiring the actual values of the data items to be stored in the user data object. In example embodiments, the use of references may reduce the regulatory burden on the data owner.

In example embodiments, an interaction represents a user contact. Interactions may comprise a single work record for some or all of the ongoing and past conversations over one or multiple channels between entity representative(s), system(s), and contact(s), and/or data needed to provide personalized and contextual user engagement. Interactions enable developers to build structured, directed communication workflows with the capability to address reporting and audit needs. In example embodiments, in a contact center context, an interaction may represent a contact center work item that needs to be processed by the contact center representative

An interaction may represent a user engagement. In example embodiments, it maps to an end-customer. A user can participate in one or more simultaneous interactions.

An interaction may be omnichannel. For example, Interactions support synchronous channels (e.g., voice, video) and asynchronous channels (e.g., chat, messaging, email) supported by a communication platform.

An interaction supports custom channels. In example embodiments, this allows entities to route any piece of work in an organization while providing context and a holistic view of each touchpoint for a user.

An interaction may be channel agnostic and/or it may be performed over 0 or more communication channels, including custom channels, and/or over a non-contiguous timeline.

Channels of an interaction may be agnostic to external, internal humans or systems as participants. At a given time, Interactions channels may have zero or more participants.

An interaction may get offered (e.g., via an invitation) to one or many users or systems, such as contact center representatives or machine-learning systems, and the users or systems may accept or decline the interaction for processing.

An interaction may have a state which includes active, inactive (similar state parked or snoozed), and closed. In example embodiments, once closed, an interaction cannot reactivate. It can be closed by humans or systems.

An interaction may have a well-defined start and end signal and duration with a disposition.

An interaction may include a container to log and retrieve real-time and historical conversations and events. Logged interactions may be stored in a data object specially configured to represent the interaction data over a timeline.

An interaction may serve as a source of truth for data required to derive metrics, calculate KPIs, and/or route the interaction to the right available entity representative.

An interaction may get grouped in zero or more views. Views group interaction by attributes such as time, system state, and attached tags. Views are versioned and have a known refresh rate to support real-time and historical use cases. The views may be surfaced in one or more user interfaces.

An interaction may expose an interface for orchestrating user (e.g., customer) engagement workflows such as routing, channel control operations such as hold, transfer, barge, whisper, and/or post-wrap-up actions, etc.

An interaction may include a resource to handle user contacts and/or a container for omnichannel conversations. In example embodiments, an interaction exposes an interface to manage channels and participants attached to a user contact.

An interaction may have one or more states. These states may include any of the following states: Closed: The interaction is considered to be complete and no further activity will happen. In example embodiments, a closed interaction cannot be reopened but additional context can be added to it. Inactive: The interaction becomes inactive if Activity pauses on it for some duration. A user or a system can put interaction in Inactive state. More activity can take place which will bring the interaction back to an active state. Active: The interaction is created in Active state.

In example embodiments, interactions are represented as a single work record for all the ongoing conversations over one or multiple channels between a business representative(s) or a system (such as IVR, chatbot, etc.) and the user. Data needed from different systems/applications to support one or more topics associated with each interaction and/or from other business backend operations that can bring information to help provide personalized, contextual user engagement. Interactions may allow entities to build structured, directed communication workflows with capability to address reporting and audit needs. It supports voice and digital channels, including email as asynchronous channels, with messaging and email channels through unified omni-channel conversations. Interactions also support custom channels allowing entities to route any piece of work in an organization while providing context and a holistic view of each and every touch point for a user.

The system provides a single source of truth about anything that has happened during or after the life cycle of an interaction. It includes a single data source for all real-time and historical data to derive metrics, calculate KPIs, and to route the interaction to the right available representative or system.

Behind Interactions sits a well-defined data model called an Interaction Detail Record (IDR). IDR is a representation of the Interactions from being created until closed. It is a cradle-to-grave view, highlighting who did what and when. Although IDR's may be defined to address specific contact center needs, they are not exclusively for Contact Centers. The IDR can address the requirements of any entity communicating in which internal users, such as representatives, communicate internally with each other or with outside users, such as customers.

Each interaction consists of participants that represent the parties in the interaction that contribute to the communication channel. Examples of participants are External (e.g., a customer), User (e.g., an agent), IVR, Queue, Bot, or System. Participants communicate using specific channels which are represented in the data model of Interactions. An interaction maintains a roster of one or more participants which each may be connected to one or more channels. With each state change, more granular parts demarcate noteworthy differences in each timespan, such as when the state of a voice channel goes from talking to on hold.

Parts are the atoms of an interaction. In example embodiments, the system may be configured to incrementally build a detailed record view in real/near-real-time as each part occurs. Each part contains a collection of attributes/dimensional data specific to that level of the detail record hierarchy (e.g., ANI/DNIS/email, state, queue id, team id, user id, direction, disposition code, disconnect reason, etc.). Each part may intrinsically carry specific context and information to support very granular drill-down.

For example, the agent parts convey relevant identifiers (e.g., queue, user, interaction, and disposition codes), channel actions (e.g. when did the agent put the user on hold), and state changes (e.g. when an interaction becomes inactive). Another example is the system participants such as ACD/queue. For these participants, parts may contain a record of the routing decisions employed in order to get the interaction routed to an agent (e.g., skills-based routing). As a final example, the IVR/bot participant can also include important context (e.g. id/version of the bot employed in that interaction and which conditional/control branches the user traversed and when, etc.).

In summary, every participant in an interaction may play a particular role and generate unique parts that are captured in an IDR for storage and further analysis.

In example embodiments, an interaction represents a single work item that needs to be processed. It represents a contact between an entity representative and a user related to the same or a similar topic. Interactions are channel-agnostic and may represent voice, web chat, SMS, WhatsApp, Email, and so on, and can support multiple channels simultaneously. Interactions may support multi-party conversations.

In example embodiments, the disclosed API facilitates live message and file exchange between multiple participants on supported channels (SMS, MMS, Whatsapp, in-app chat, email, and so on). The API may explicitly focus on facilitating active communication and may provide search tools that enable discovery of ongoing and archived conversations or communications, and include non-message “events” in the timeline like “participant added to the thread.”

The user journey is about the user life-cycle and total context of the user incorporating all the communications throughout the life time. A journey would be one or more interactions as well as other, non-interaction data. This view of a user lifecycle spanning over several specific encounters (interactions) can give broader context to an agent about the user and be used to build user interfaces.

Context Store is the storage of messages, conversations, events, timelines, and the relationships between these items on a timeline. Interactions may add to the Context Store, allowing users to see journey information that includes interaction and non-interaction data.

In example embodiments, Interaction Detail Records are different from the context store in its near/real-time requirement, its structured data model, and its defined start and end-time.

In example embodiments, a touchpoint record or engagement record is a user touchpoint is a record of any time a consumer interacts with a company, through an interaction, managed by an agent, an interaction managed by a bot, a website, a CDP, or an application. From now on touchpoints and Timeline Records will be mentioned and they can be treated as the same term in the Timeline Service context.

In example embodiments, a timeline includes a list of touchpoints of a user associated with a company over a specific period of time. It typically includes key touchpoints. such as purchase or service interactions, support requests, and communication with the company. A user timeline is used to understand the user's experience and identify any pain points or areas for improvement.

In example embodiments, a timeline record includes a touchpoint that might represent any interaction of users with the company using a communication platform or through their external systems.

In example embodiments, platform timeline records include a type of touchpoint or timeline record of any time a consumer interacts with an entity using internal communication platform services or external (e.g., CDP) services.

In example embodiments, interaction timeline records include a type of touchpoint or Timeline record of any time a user interacts with an entity using Interactions. An interaction might be managed by or surface to an agent, by a bot an IVR. etc., or any participant that can handle Interactions in the system.

In example embodiments, external timeline records include a type of touchpoint or Timeline record of any time a user interacts with an entity outside of a communications context; for example, the user submitting a loan application. signing a contract with the company, or interacting with external systems like CDPs, company websites, or company systems, etc.

A major pain point for users is repeating themselves with each interaction or transfer. In order to remove this repetition, the intention is to provide representatives, systems, and other parties with a timeline that lists previous interactions. The timeline may be retrieved for the user when they connect with a representative and may be drawn from interactions (including communication channels and participants), user profiles, and topics.

In example embodiments, a custom application inputs a user identifier (e.g., via the API) and receives a timeline as output, such as a timeline data object and/or a rendered timeline. In example embodiments, the timeline services are only available to authenticated actors with authorized roles (e.g., using roles and permissions as defined by the entity).

In example embodiments, a method of integrating communication data and user data is disclosed. A data object corresponding to the user is generated. The generating includes identifying a reference to communication information pertaining to the user and identifying a reference to user information pertaining to the user. The communication information is managed by a first system. The user information is managed in a second system. The second system is separate from the first system. Based on a receiving of a request via an API, the data object is used to access a subset of the user information and a subset of the communication information. The subset of the user information and the subset of the communication information are identified in one or more parameters of the API. The subset of the user information and the subset of the end communication information is provided for presenting together in a user interface of a client device.

In example embodiments a method of processing one or more interactions using a timeline is disclosed. Data pertaining to a plurality of interactions is stored in a timeline record in real-time when each of the plurality of interactions occurs. Each of the plurality of interactions is associated with one or more topics and an identifier of a user. Each of the one or more topics identifying an intent of the user. A request for a subset of the data that corresponds to an additional interaction of the user is received via an API. The subset identified in one or more parameters of the API. In response to the request, the subset of the data is provided for surfacing in a graphical user interface such that one or more representatives can make a determination of whether to accept an invitation to process the additional interaction.

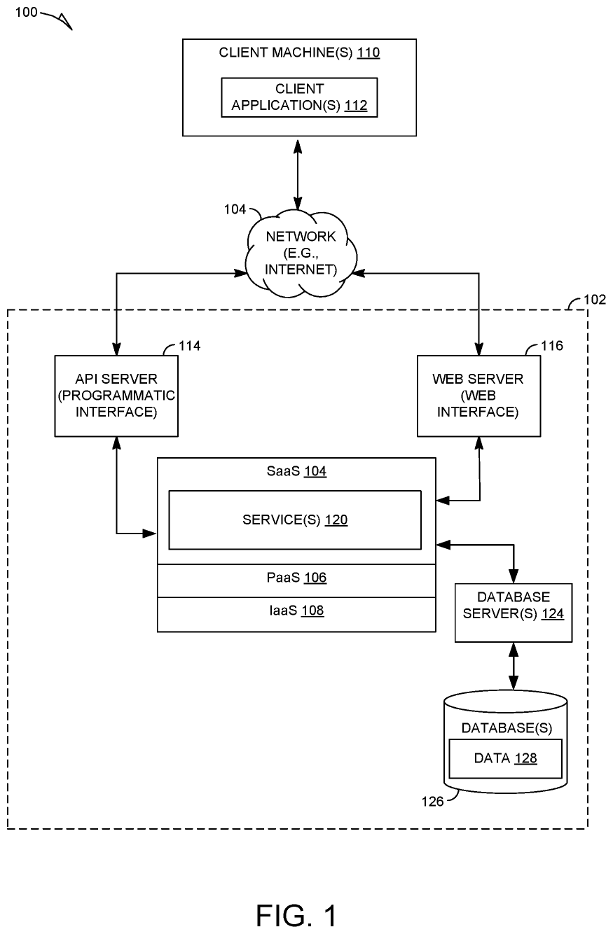

FIG. 1 is a network diagram depicting a system 100 within which various example embodiments may be deployed. A networked system 102, in the example form of a cloud computing service, such as Microsoft Azure or other cloud service, provides server-side functionality, via a network 104 (e.g., the Internet or Wide Area Network (WAN)) to one or more endpoints (e.g., client machines 110). FIG. 1 illustrates client application(s) 112 on the client machines 110. Examples of client application(s) 112 may include a web browser application, such as the Internet Explorer browser developed by Microsoft Corporation of Redmond, Washington or other applications supported by an operating system of the device, such as applications supported by Windows, iOS or Android operating systems. Each of the client application(s) 112 may include a software application module (e.g., a plug-in, add-in, or macro) that adds a specific service or feature to the application.

An API server 114 and a web server 116 are coupled to, and provide programmatic and web interfaces respectively to, one or more software services, which may be hosted on a software-as-a-service (SaaS) layer or platform 104. The SaaS platform may be part of a service-oriented architecture, being stacked upon a platform-as-a-service (PaaS) layer 106 which, may be, in turn, stacked upon a infrastructure-as-a-service (IaaS) layer 108 (e.g., in accordance with standards defined by the National Institute of Standards and Technology (NIST)).

While the applications (e.g., service(s)) 120 are shown in FIG. 1 to form part of the networked system 102, in alternative embodiments, the applications 120 may form part of a service that is separate and distinct from the networked system 102.

Further, while the system 100 shown in FIG. 1 employs a cloud-based architecture, various embodiments are, of course, not limited to such an architecture, and could equally well find application in a client-server, distributed, or peer-to-peer system, for example. The various server applications 120 could also be implemented as standalone software programs. Additionally, although FIG. 1 depicts machines 110 as being coupled to a single networked system 102, it will be readily apparent to one skilled in the art that client machines 110, as well as client applications 112, may be coupled to multiple networked systems, such as payment applications associated with multiple payment processors or acquiring banks (e.g., PayPal, Visa, MasterCard, and American Express).

Web applications executing on the client machine(s) 110 may access the various applications 120 via the web interface supported by the web server 116. Similarly, native applications executing on the client machine(s) 110 may access the various services and functions provided by the applications 120 via the programmatic interface provided by the API server 114. For example, the third-party applications may, utilizing information retrieved from the networked system 102, support one or more features or functions on a website hosted by the third party. The third-party website may, for example, provide one or more promotional, marketplace or payment functions that are integrated into or supported by relevant applications of the networked system 102.

The server applications 120 may be hosted on dedicated or shared server machines (not shown) that are communicatively coupled to enable communications between server machines. The server applications 120 themselves are communicatively coupled (e.g., via appropriate interfaces) to each other and to various data sources, so as to allow information to be passed between the server applications 120 and so as to allow the server applications 120 to share and access common data. The server applications 120 may furthermore access one or more databases 126 via the database servers 124. In example embodiments, various data items are stored in the database(s) 126, such as the system's data items 128. In example embodiments, the system's data items may be any of the data items described herein.

Navigation of the networked system 102 may be facilitated by one or more navigation applications. For example, a search application (as an example of a navigation application) may enable keyword searches of data items included in the one or more database(s) 126 associated with the networked system 102. A client application may allow users to access the system's data 128 (e.g., via one or more client applications). Various other navigation applications may be provided to supplement the search and browsing applications.

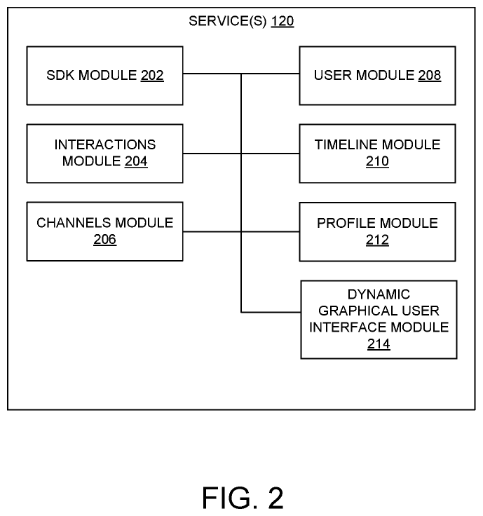

FIG. 2 is a block diagram illustrating example modules of the system's service(s) 120. In example embodiment, an SDK module 202 is configured to provide access to one or more APIs for performing one or more tasks, as described herein. An interactions module 204 is configured to provide access to one or more APIs for managing interactions or interactions services and/or performing one or more related tasks, as described herein. A channels module 206 is configured to provide access to one or more APIs for managing channels or channel services and/or performing one or more related tasks, as described herein. A users (or participant) module 208 is configured to provide access to one or more APIs for managing users or user services and/or performing one or more related tasks, as described herein. A timeline module 210 is configured to provide access to one or more APIs for managing timelines or timeline services and/or performing one or more related tasks, as described herein. A profile module 212 is configured to integrate profile (e.g., user profile) data with communication platform data, as described herein. A dynamic graphical user interface module 214 is configured to cause one or more user interfaces to be presented on one or more devices, as described herein.

From the entity's perspective, the one or more profile data APIs allow the entity to integrate profile data of their users, such as user profile data stored in one or more applications, with data pertaining to interactions and/or user communications, such as data associated with a communication platform. In example embodiments, the entity can use the one or more APIs (e.g., in one or more custom applications) to ensure that representatives of the entity have a better view and understanding of the users when communicating with them. The entity can also manage configurations associated with their data integrates to, for example, create, view, and delete the configurations. The entity can also lookup user profile data stored in one or more third-party or external applications. The entity can also seamlessly integrate communication platform data with user profile data so that the entity can use the third party or external applications to store and/or resolve user profiles and use the communication platform to drive context about the user to the entity's representatives. The entity can also search user profiles (e.g., based on name, phone number, and/or email address) (e.g., so that the entity's representatives can find the right information about the user when communicating with the user). The entity can also securely connect to one or more webhooks (e.g., registered by the user) that may be used to authenticate and/or get access to the user profiles. The entity can also build functionalities to create new user profiles or edit existing user profiles (e.g., based on input from a representative or in an automated fashion).

From an administrator's perspective, the one or more APIs allow the administrator to view the details of the data integration, such as third-party account ID, name, URL, and endpoints that have been registered that drive the connection, look up, creation of profiles, and other features that have been registered with the entity's account (e.g., to get clarity on the data sources being used to drive the user profiles integration).

From a representative's perspective, the one or more APIs allow the representative to be able to view user information along with history or user journeys associated with their interactions. The representative is able to look up user profiles (e.g., by name, email address, or phone number) in order to get context and understand of the user. The representative can update a user's information to be up-to-date and correct to ensure that it is easier and more seamless to have future communications with the user.

In example embodiments, one or more APIs are provided that query information associated with the user and provide a point of context associated with the user. An aggregated user profile data object can be leveraged by other functionalities that use aggregated user profile data, such as a Timeline, Omnichannel Canvas, Flows for routing, and so on.

An entity can build a connector, which is the implementation of the interface. With this interface, users can integrate one or more softwares that store user profile information.

In example embodiments, a connector or an integration is provided for a specific software, such as a specific CDPI software, that helps the entity to seamlessly integrate data from the CDP with other data associated with a communication platform, such as communication and/or interaction data.

In example embodiments, the one or more APIs provided include one or more of a Profile Connector Interface, a Profile Connector Interface, a Profile Interface, an Address Resource Interface, an Additional Contact Resource Interface, or a Profile Connection Resource Interface.

In example embodiments, an entity implements the Profile Connector Interface (e.g., in a custom application) to enable the one or more of the following actions: mapping or determining an incoming communication to their user profile, creating a profile for a new user, updating the profile for an existing user, or searching for a user based on inputs, such as a phone number, name, or email address.

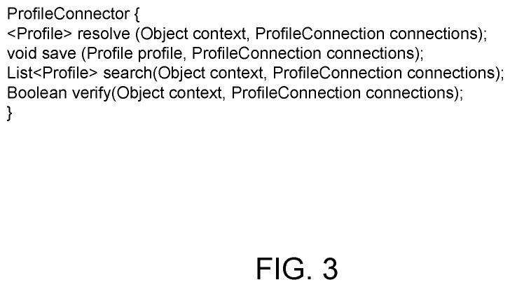

FIG. 3 is a pseudo-code listing of an example implementation of a Profile Connector Interface.

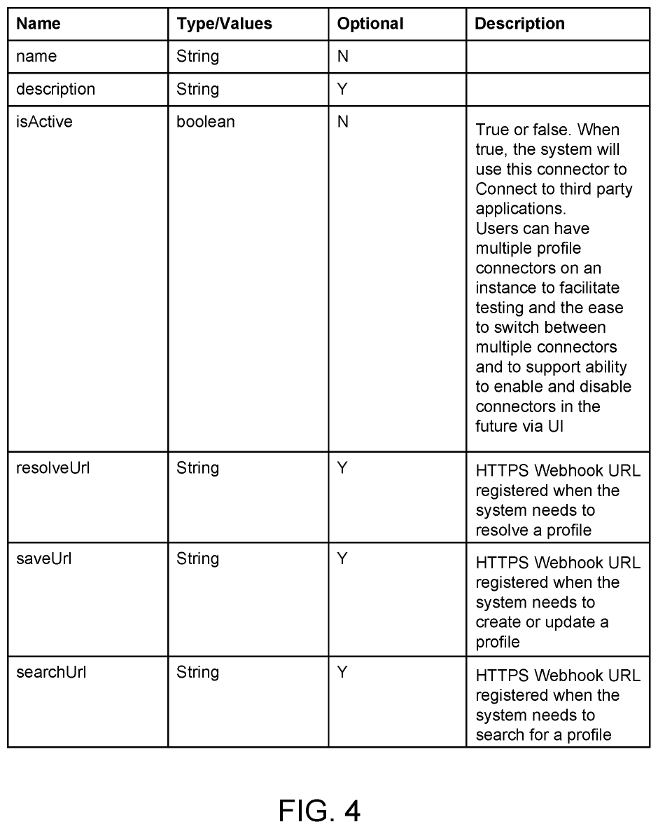

FIG. 4 is table showing example parameters of an example Profile Connector Interface. In example embodiments, the one or more parameters include one or more of name, description, isActive, resolveUrl, ssaveUrl, or searchUrl, as described. In example embodiments, one or more of the parameters may be optional parameters.

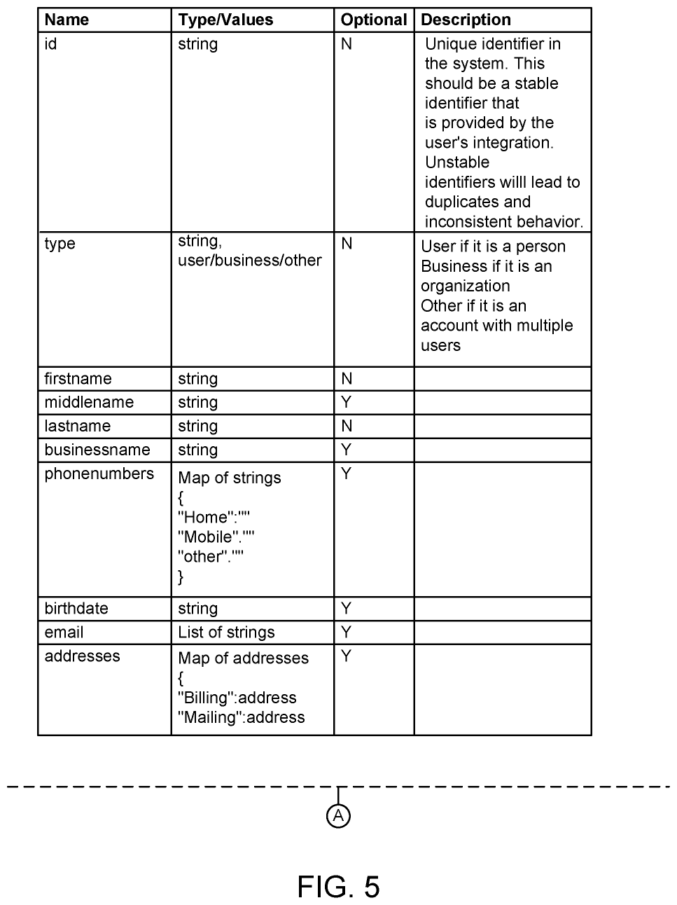

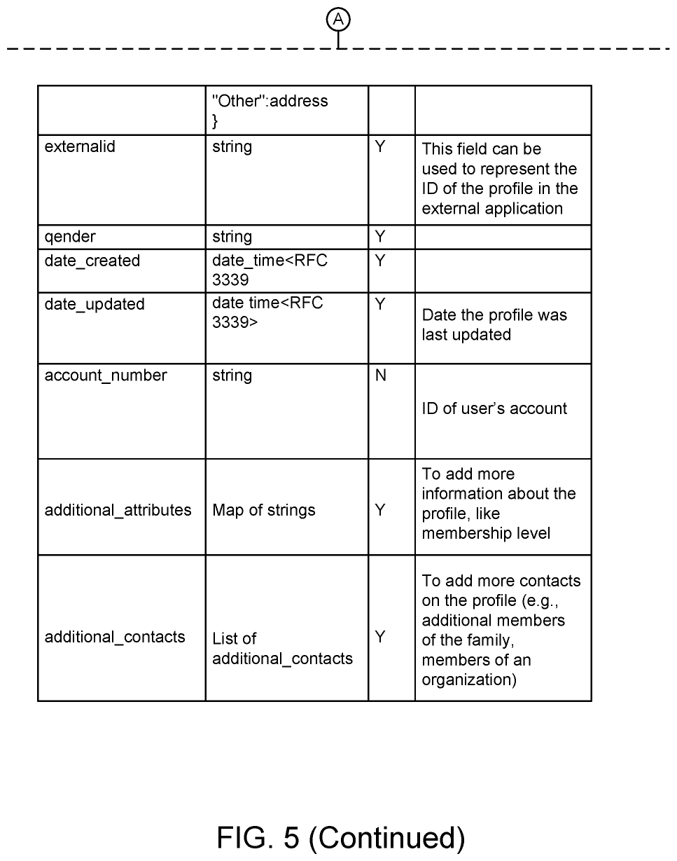

FIG. 5 is a table showing example parameters of an example Profile Interface. In example embodiments, the one or parameters include id, type, firstname, middlename, lastname, businessname, phonenumbers, birthdate, email, addresses, externalid, gender, date_create, date_uploaded, account_number, additional_attributes, or additional_contacts. In example embodiments, one or more of the parameters may be optional parameters.

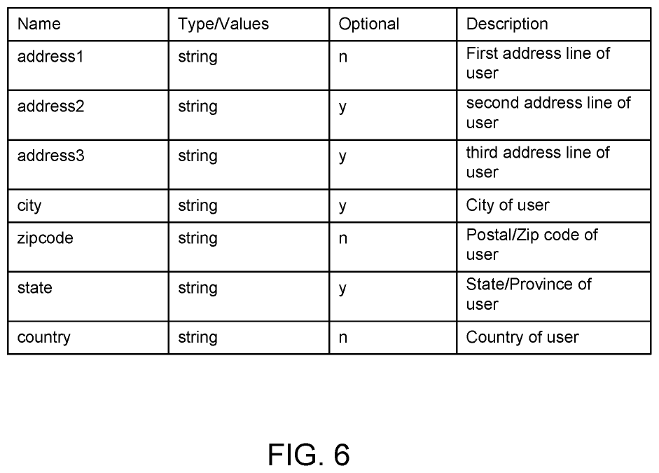

FIG. 6 is a table showing example parameters of an example Address Resource Interface. In example embodiments, the one or parameters include address1, address2, address3, city, zipcode, state, or country. In example embodiments, one or more of the parameters may be optional parameters.

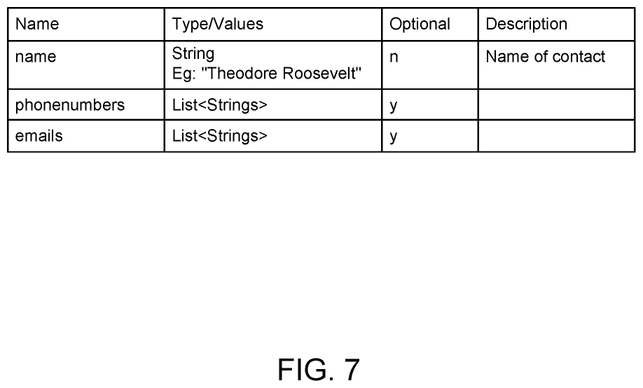

FIG. 7 is a table showing example parameters of an example Additional Contact Resource Interface. In example embodiments, the one or parameters include name, phonenumbers, or emails. In example embodiments, one or more of the parameters may be optional parameters.

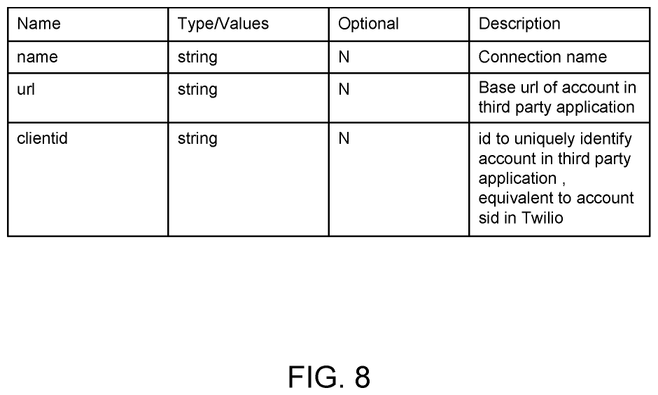

FIG. 8 is a table showing example parameters of an example Profile Connection Resource Interface. In example embodiments, the one or parameters include name, URL, or Client ID. In example embodiments, one or more of the parameters may be optional parameters.

Example scenarios for using the one or more APIs include resolving an incoming communication of a user having user profile data stored in a generic external system, resolving an incoming communication of a user having user profile data stored in a specific external system, creating or updating a user profile from within a flow, or searching user profiles.

In example embodiments, resolving an incoming communication of a user having a user profile stored in a generic external system includes one or more of the following operations: creating a user profile connection resource (e.g., via a POST call to the one or more APIs), implementing resolve functionality of a connector (e.g., ProfileConnector) interface (e.g., in a back-end server function or a function of a communication platform), registering the resolve functionality as a resolve endpoint, or testing the resolve functionality with the external system.

In example embodiments, when an instance is created, one or more flows for inbound interactions are created. Each flow automatically includes a user profile block which may be called for getting the user context before a kickoff of the routing for the user. The profile block may contain an Action field, which maps the action on an external application, such as resolve, create, search, or save, to the profile connector interface. The block part of this flow sets the action as it resolves.

In example embodiments, resolving an incoming communication of a user having user profile data stored in a specific external system, such as a specific CDP, includes the same operations as for the generic external system. However, except for the creating a user profile connection resource (e.g., via a POST call to the one or more APIs) operation, the operations are pre-implemented (e.g., as a template corresponding to the specific external system). Thus, the templatized operations need only be deployed in the entity's environment to implement the user data profile APIs.

To support creating and updating of user profiles, an entity can add the ability from within a flow (e.g., to support automatic creating or updating of user profiles) or they can add the ability within a UI component, such as a Timeline user interface component (e.g., to allow representatives of the entity to create or update user profiles).

In example embodiments, operations for adding the ability within a flow include one or more of the following: creating a profiles connection resource (e.g., via a POST call to API), implementing a save functionality of a connector (e.g., ProfileConnector) interface (e.g., in a back-end server or as a function of a communication platform), registering the save functionality as a save endpoint, and/or creating a user profile block to call the create and update functions of a user profile API. In example embodiments, to save, the action name of a user profile block is set.

In example embodiments, operations for adding the ability within a UI component include one or more of the following: creating a user profile connection resource (e.g., via a POST call to the API), implementing a save functionality of a connector (e.g., ProfileConnector) interface (e.g., in a back-end server or as a function of a communication platform), registering the save functionality as a save endpoint, and/or saving changes to a user profile within the UI component via the SDK and/or APIs for the user profile (e.g., via a profileObservable.save( ) function). In example embodiments, entities handle the asynchronous nature of connecting and saving changes to a third-party or external application (e.g., a CDP).

In example embodiments, the user profile SDK includes one or more pre-built UI components (e.g., for a representative UI experience). In example embodiments, one or more representatives of an entity can start a conversation with a user via the UI components. Additionally, the one or more representatives can search for user profiles (e.g., stored in a third-party or external application, such as a CDP) and choose a user with which to start a conversation.

In example embodiments, the pre-built UI components can be embedded in one or more custom applications, such as one more custom contact center applications. In example embodiments, operations for embedding the UI components include one or more of the following: creating a connection resource (e.g., a Profile Connection resource) (e.g., via a POST call to the API, implementing a search functionality interface (e.g., an ProfileConnector interface) in a back-end server or as a function of a communication platform, and/or registering the search functionality as a search endpoint. When an instance of the system is created, the system automatically creates one or more flows to enable representatives to start a conversation with a user. These flows will automatically include a user profile block with an action field set to search.

In example embodiments, similar steps may be performed for creating and updating user profiles—for example, creating a connection resource, implementing a create user profile interface or an updating user profile interface, and/or registering the interface as a create user profile end point or a update user profile endpoint.

In example embodiments, administrators of an entity can access the details of the data integration of user profile data and communication data, including third-party or external system account ID, name, URL, and endpoint that have been registered that drive a connection. In example embodiments, administrators can access the lookup and/or creation profile features that have been registered with one or more accounts associated with the entity to get clarity on integrations being used on each account. In example embodiments, the accessed data is surface in an administration user interface, such as a console user interface.

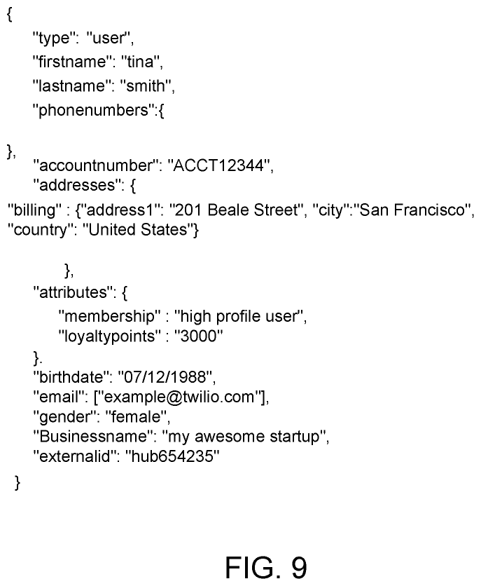

FIG. 9 is an example listing of pseudo-code of an example of a user profile for when the user is a person or individual.

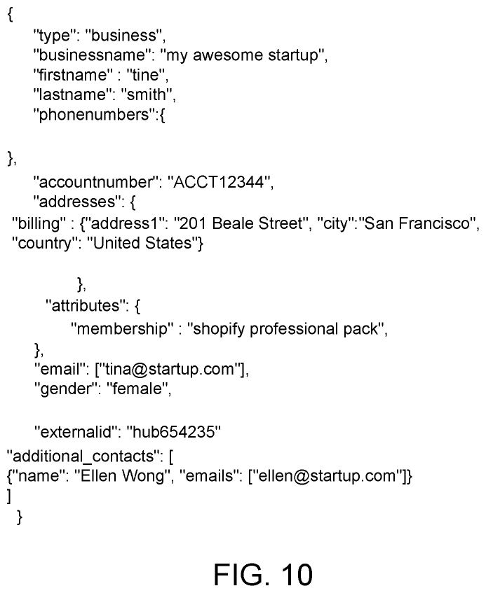

FIG. 10 is an example listing of pseudo-code of an example of a user profile when the user is a business (e.g., an online shop having one or more users).

In example embodiments, an administrator of an entity may create a data integration (e.g., using a console user interface having one or more UI components for taking details for connecting to third-party or external applications). In example embodiments, the administrator provides a mapping of objects from one or more external source (e.g., applications, such as CDP applications) to one or more user profile data objects. In example embodiments, a mapping can be provided via a UI or as a file (e.g., a JSON/XML file). In example embodiments, the mapping details include one or more of connections information, an external object name, and a mapping of fields.

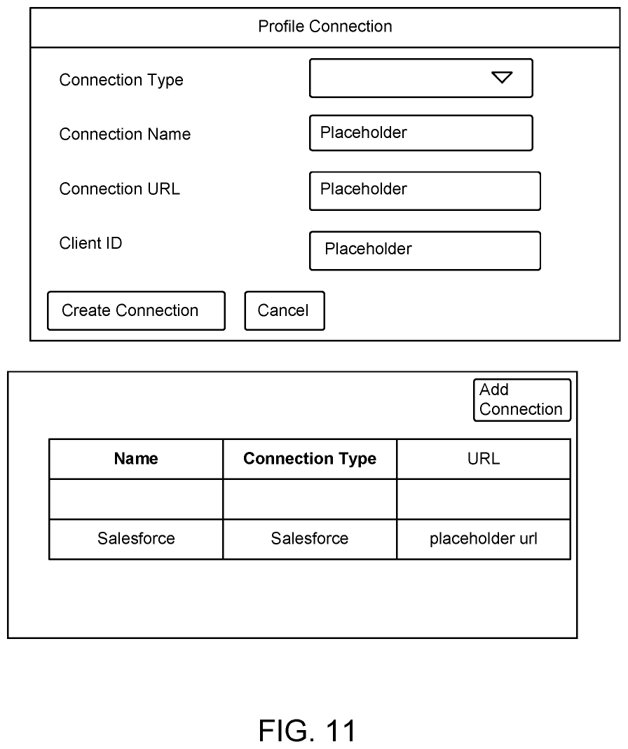

FIG. 11 is a screenshot of an example user interface for managing one or more connections. In example embodiments, a user, such as an administrator, can use the user interface to create one or more connections. In example embodiments, the administrator creates a connection by specifying a connection type, connection name, connection URL, and/or client ID. In example embodiments, one or more connections can be added to a set of pre-built connections, such as a pre-built connection for an external application (e.g., Salesforce).

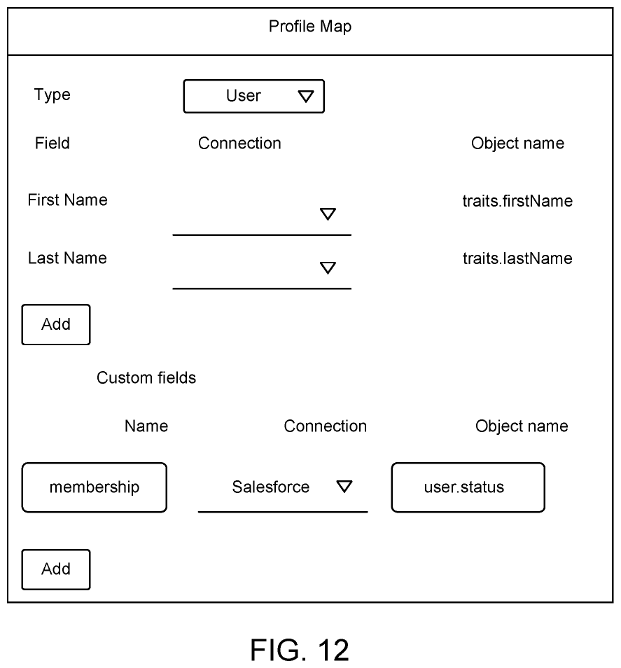

FIG. 12 is a screenshot of an example user interface for mapping fields in an external source to a user profile data object. In example embodiments, the administrator specifies a type (e.g., user or business), one or more source/connection fields, one or more destination fields corresponding to a user profile data object, and/or one or more custom fields (e.g., name, connection/source, and/or objectname).

In example embodiments, examples of supported endpoint or ProfileConnections APIs may include one or more of the following:

GET /v1/ACxxx/ProfileConnections
Lists all the configs of user profile connections on an account
   POST /v1/ACxxx/ProfileConnections
Creates a new Profile Connection
   GET /v1/ACxxx/ProfileConnections/AICPxxxxxxx
Fetches a Profile Connection
   POST /v1/ACxxx/ProfileConnections/AICPxxxxxxx
Updates a Profile Connection
   DELETE /v1/ACxxx/ProfileConnections/AICPxxxxxxx
Deletes a Profile Connection

In example embodiments, examples of methods that may be implemented by an entity to support user profiles may include one or more of the following:
<Profile> getProfile (List<ProfileConnections> connections, Context context)
Connections=>all the connections that have been registered on the account; Context=>Context object will contain all the info that the system knows about the current communication. The entity will use this to resolve to a user in the external application.
void updateProfile (List<ProfileConnections> connections, Profile profile)
Connections=> all the connections that have been registered on an account

The updated profile info that needs to be updated externally.

List <Profile> searchProfiles (List<ProfileConnections> connections, Context context)

In example embodiments, there can be multiple connections to enable entities to incorporate data from multiple sources. The following listing is an example of a file mapping:

```
<Profile>
<Connection>
  <configuration>
    </configuration>
<mapping>
</mapping>
</Connection>
<Connection>
  <configuration>
    </configuration>
<mapping>
</mapping>
</Connection>
</Profile>
```

In example embodiments, an entity can integrate data from a generic third-party application, such as a CDP, using one or more of the following operations: implementing resolve, create, or update endpoints that perform the functions of resolving, creating, and updating of a user profile data object using the generic third-party application (e.g., using an interface); adding a generic connector block to a flow, wherein the generic connector includes one or more of the following inputs: third-party application connection details (e.g., registered as a user profile connection resource, such as via a POST call to the API) and/or an identifier of the created connection as an input to the connector); creating the endpoints of the implementation. After the connector is registered, the system calls the endpoints registered as part of the connector (e.g., to drive one or more components, such as a timeline component).

In example embodiments, an entity can integrate data from a known external or third-party application, such as a specific CDP application, using one or more of the following operations: adding a pre-built connector block (e.g., a connector block template) for the specific application to a flow using the API. In example embodiments, the connector block includes connection details specific to the application, such as connection details registered via a user profile connection resource, as described herein. In example embodiments, the entity passes an identifier of the connection resource as an input to the connector block.

### Example Mobile Device

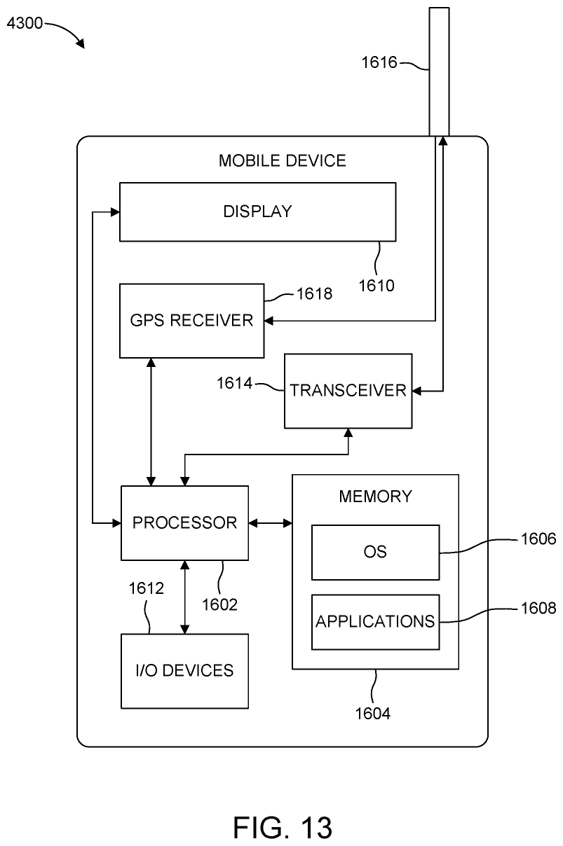

FIG. 13 is a block diagram illustrating a mobile device 4300, according to an example embodiment. The mobile device 4300 can include a processor 1602. The processor 1602 can be any of a variety of different types of commercially available processors suitable for mobile devices 4300 (for example, an XScale architecture microprocessor, a Microprocessor without Interlocked Pipeline Stages (MIPS) architecture processor, or another type of processor). A memory 1604, such as a random access memory (RAM), a Flash memory, or other type of memory, is typically accessible to the processor 1602. The memory 1604 can be adapted to store an operating system (OS) 1606, as well as application programs 1608, such as a mobile location-enabled application that can provide location-based services (LBSs) to a user. The processor 1602 can be coupled, either directly or via appropriate intermediary hardware, to a display 1610 and to one or more input/output (I/O) devices 1612, such as a keypad, a touch panel sensor, a microphone, and the like. Similarly, in some embodiments, the processor 1602 can be coupled to a transceiver 1614 that interfaces with an antenna 1616. The transceiver 1614 can be configured to both transmit and receive cellular network signals, wireless data signals, or other types of signals via the antenna 1616, depending on the nature of the mobile device 4300. Further, in some configurations, a GPS receiver 1618 can also make use of the antenna 1616 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

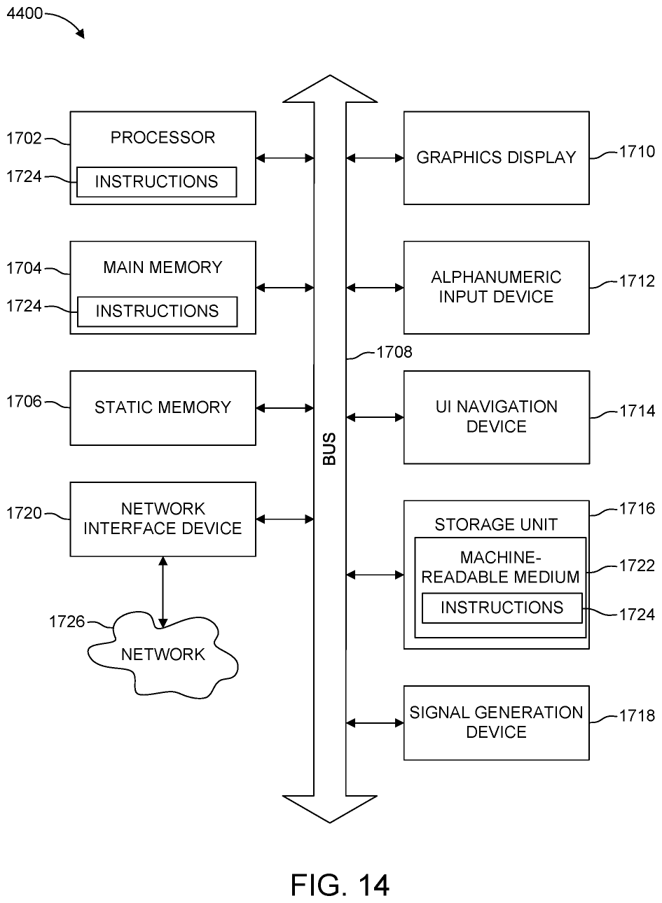

FIG. 14 is a block diagram of an example computer system 4400 on which methodologies and operations described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 4400 includes a processor 1702 (e.g., a central processing unit (CPU), a graphics processing unit (GPU) or both), a main memory 1704 and a static memory 1706, which communicate with each other via a bus 1708. The computer system 4400 may further include a graphics display unit 1710 (e.g., a liquid crystal display (LCD) or a cathode ray tube (CRT)). The computer system 4400 also includes an alphanumeric input device 1712 (e.g., a keyboard or a touch-sensitive display screen), a user interface (UI) navigation device 1714 (e.g., a mouse), a storage unit 1716, a signal generation device 1718 (e.g., a speaker) and a network interface device 1720.

### Machine-Readable Medium

The storage unit 1716 includes a machine-readable medium 1722 on which is stored one or more sets of instructions and data structures (e.g., software) 1724 embodying or utilized by any one or more of the methodologies or functions described herein. The instructions 1724 may also reside, completely or at least partially, within the main memory 1704 and/or within the processor 1702 during execution thereof by the computer system 4400, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions 1724 or data structures. The term “machine-readable medium” shall also be taken to include any tangible medium that is capable of storing, encoding or carrying instructions (e.g., instructions 1724) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more computer processors;
one or more computer memories;
a set of instructions incorporated into the one or more computer memories, the set of instructions configuring the one or more computer processors to perform operations, the operations comprising:
generating a data object corresponding to a user, the generating including identifying a reference to communication information pertaining to the user and identifying a reference to user information pertaining to the user, the communication information managed by a first system, the user information managed in a second system, the second system being separate from the first system,
based on a receiving of a request via an API, using the data object to access a subset of the user information and a subset of the communication information, the subset of the user information and the subset of the communication information identified in one or more parameters of the API; and
providing the subset of the user information and the subset of the end communication information for presenting together in a user interface of a client device.

2. The system of claim 1, wherein the using of the data object to access the subset of the user information and the subset of the communication information is performed in real time without querying the second system.

3. The system of claim 1, wherein the generating of the data object includes accessing a connector object, the connector resource, the connector resource created via the API.

4. The system of claim 1, wherein the user interface includes a representation of a timeline corresponding to the user.

5. The system of claim 3, wherein the connector resource maps fields of the data object to fields associated with the user information.

6. The system of claim 5, wherein the mapping of the fields by the connector resource is based on inputs received via an administrative console.

7. The system of claim 6, wherein the inputs include one or more of a name of a source field name and a destination field name, the source field name corresponding to the user information managed in the second system, the destination field name corresponding to the data object.

8. A method comprising:
generating a data object corresponding to a user, the generating including identifying a reference to communication information pertaining to the user and identifying a reference to user information pertaining to the user, the communication information managed by a first system, the user information managed in a second system, the second system being separate from the first system;
based on a receiving of a request via an API, using the data object to access a subset of the user information and a subset of the communication information, the subset of the user information and the subset of the communication information identified in one or more parameters of the API; and
providing the subset of the user information and the subset of the end communication information for presenting together in a user interface of a client device.

9. The method of claim 8, wherein the using of the data object to access the subset of the user information and the subset of the communication information is performed in real time without querying the second system.

10. The method of claim 8, wherein the generating of the data object includes accessing a connector object, the connector resource, the connector resource created via the API.

11. The method of claim 8, wherein the user interface includes a representation of a timeline corresponding to the user.

12. The method of claim 11, wherein the connector resource maps fields of the data object to fields associated with the user information.

13. The method of claim 12, wherein the mapping of the fields by the connector resource is based on inputs received via an administrative console.

14. The method of claim 13, wherein the inputs include one or more of a name of a source field name and a destination field name, the source field name corresponding to the user information managed in the second system, the destination field name corresponding to the data object.

15. A non-transitory computer-readable storage medium storing a set of instructions that, when executed by one or more computer processors, causes the one or more computer processors to perform operations, the operations comprising:
generating a data object corresponding to a user, the generating including identifying a reference to communication information pertaining to the user and identifying a reference to user information pertaining to the user, the communication information managed by a first system, the user information managed in a second system, the second system being separate from the first system;
based on a receiving of a request via an API, using the data object to access a subset of the user information and a subset of the communication information, the subset of the user information and the subset of the communication information identified in one or more parameters of the API; and
providing the subset of the user information and the subset of the end communication information for presenting together in a user interface of a client device.

16. The non-transitory computer-readable storage medium of claim 15, wherein the using of the data object to access the subset of the user information and the subset of the communication information is performed in real time without querying the second system.

17. The non-transitory computer-readable storage medium of claim 15, wherein the generating of the data object includes accessing a connector object, the connector resource, the connector resource created via the API.

18. The non-transitory computer-readable storage medium of claim 15, wherein the user interface includes a representation of a timeline corresponding to the user.

19. The non-transitory computer-readable storage medium of claim 18, wherein the connector resource maps fields of the data object to fields associated with the user information.

20. The non-transitory computer-readable storage medium of claim 19, wherein the mapping of the fields by the connector resource is based on inputs received via an administrative console.
